(19) United States
(12) Patent Application Publication
(10) Pub. No.: US 2023/0276978 A1
(43) Pub. Date: Sep. 7, 2023

(54) FRONT LOADING BEVERAGE MAKING SYSTEMS AND METHODS

(71) Applicant: Senslo Inc., New York, NY (US)

(72) Inventors: Jorge B. Garcia, Rogers, AR (US); Keith Bilodeau, Plantsville, CT (US); Tristan McKeever, Montreal (CA)

(73) Assignee: Senslo Inc., New York, NY (US)

(21) Appl. No.: 18/171,656

(22) Filed: Feb. 20, 2023

Related U.S. Application Data
(60) Provisional application No. 63/311,818, filed on Feb. 18, 2022.
(60) Provisional application No. 63/311,834, filed on Feb. 18, 2022.
(60) Provisional application No. 63/335,718, filed on Apr. 27, 2022.

(51) Int. Cl. A47J 31/44; A47J 31/02; A47J 31/40

(52) U.S. Cl. CPC A47J 31/4403; A47J 31/02; A47J 31/407

(57) ABSTRACT

A drawer assembly for a capsule based brewing machine includes a housing having at least a one track on an inner side thereof. The drawer assembly includes a platform located within the housing for positioning a capsule puncturing needle. The drawer assembly includes a drawer. The drawer having at least one capsule receptacle therein, slidably engaged with the track of the housing. A method of operating drawer assembly for a capsule based brewing machine includes translating a drawer along a track of a housing from an extracted position to an inserted position, changing a vertical distance between a top surface of the drawer and a lower surface of a platform, and puncturing a capsule with a puncturing needle.

### CROSS-REFERENCE TO RELATED APPLICATIONS

This application claims priority to U.S. Provisional Patent Application Ser. No. 63/311,818, filed Feb. 18, 2022, U.S. Provisional Patent Application Ser. No. 63/311,834, filed Feb. 18, 2022, and U.S. Provisional Patent Application Ser. No. 63/335,718, filed Apr. 27, 2022. The contents of all of these applications are herein incorporated by reference in their entirety.

### BACKGROUND

### Technological Field

The present disclosure relates generally to a pod- or capsule-style beverage making machine, and specifically to a drawer mechanism for inserting and engaging the pod or capsule using a front loading machine.

### Description of Related Art

Currently, single-serve beverage pod or capsule makers use a top-loading mechanism in which a lid is opened upward, the capsule or pod is placed into position, and the lid subsequently closed to pierce the capsule's foil with a needle, allowing liquid inflow for brewing. This mechanism requires vertical space above the unit to accommodate the opening of the lid, increasing the overall vertical dimension of the beverage maker. This limits the locations in which the beverage makers can be placed or requires that they be pulled outward from beneath kitchen cupboards for use. This method can also require a substantial amount of force to close the lid.

Thus a need exists for providing a beverage maker that effectively produces a brewed beverage while allowing a user to insert the pod or capsule in an upright position, and also not change the height of the maker during open and closed positions. The present disclosure provides a solution for this need.

### SUMMARY

This disclosure is a front-loading mechanism in which a drawer moves horizontally outward to load one or multiple beverage capsules. A drawer assembly for a capsule based beverage making machine includes a housing having at least a one track on an inner side thereof. The drawer assembly includes a platform located within the housing for positioning a capsule puncturing needle. The drawer assembly includes a drawer. The drawer having at least one capsule receptacle therein, slidably engaged with the track of the housing.

As the drawer is pushed inward, a spring system consisting of one or multiple springs assists with the vertical piercing action of the foil. A spring-loaded push latch is used to lock the assembly into the brewing position. The design also features an outer sealing ring which seals against the outer wall of the beverage capsule (as opposed to conventional beverage capsule makers, which seal against the foil itself), preventing buckling of the capsule foil, ensuring a proper puncture and more consistent brewing.

In some embodiments, the drawer can have an extracted position and an inserted positon. A vertical distance between a top surface of the drawer and a lower surface of the platform can change as the drawer moves from the extracted position and the inserted position.

In certain embodiments, the platform can be part of a head assembly. The head assembly can be configured and adapted to move vertically with respect to the drawer as the drawer moves from the extracted position to the inserted position. The drawer can include a ramp element in abutment with a lower surface of the platform of the head assembly. The abutment of ramp element can be configured and adapted to vertically raise or lower the head assembly as the drawer moves from the extracted position to the inserted position. The housing can include at least one guide slot and wherein the platform includes at least one guide pin positioned within the guide slot, wherein the at least one guide pin is configured and adapted to move vertically within the guide slot.

In certain embodiments, the drawer can be configured and adapted to move vertically with respect to the platform as the drawer moves from the extracted position to the inserted position. The drawer can include at least one guide pin configured and adapted to engage with the at least one track of the housing. The at least one track of the housing can include a first section defining a first longitudinal axis in a first direction and a second section defining a second longitudinal axis in a second direction. The second direction can be at an angle relative to the first direction. The second section can be angled upwards toward a top surface of the housing such that, as the drawer moves from the extracted position and the inserted position, the at least one track can guide the at least one guide pin, and thereby the drawer, towards the platform.

In some embodiments, the platform is part of a head assembly. The drawer assembly can include a gear interface between the head assembly and the drawer. The gear interface can include a double pinion gear, a first rack gear and a second rack gear. The first rack gear can be operatively connected to the drawer for common movement therewith. The second rack gear can be operatively connected to the platform for common movement therewith. A first set of teeth of the double pinion gear can be meshed with the first rack gear and a second set of teeth of the double pinion gear can be meshed with the second rack gear such that rotation of the pinion gear is configured and adapted to drive at least one of horizontal translation of the first rack gear or vertical translation of the second rack gear. The drawer can include an electric motor coupled to the double pinion gear to drive rotation thereof.

In some embodiments, the drawer can be a single drawer having a plurality of capsule receptacles defined therein. The drawer can be one of a plurality of discretely movable drawers each having at least one respective capsule receptacle defined therein. The platform can be one of a plurality of discretely movable platforms that are part of respective discretely movable head assemblies. Respective capsule puncturing needles can be operatively coupled to each platform. The drawer assembly can include a respective gear interface engaged with each discretely movable platform. Each gear interface can include a double pinion gear, a first rack gear and a second rack gear. The first rack gear can be operatively connected to the drawer for common movement therewith and the second rack gear can be operatively connected to a respective one of the discretely movable platforms for common movement therewith.

In some embodiments, each gear interface includes a double pinion gear and a rack gear operatively connected to a respective one of the discretely movable platforms for common movement therewith. The drawer assembly can include a plurality of electric motors, each electric motor coupled to a respective gear interface.

In certain embodiments, the drawer assembly can include a brew timer operatively connected to the platform for triggering a change in a vertical distance between a top surface of the drawer and a lower surface of a platform of the head assembly at a desired time. This allows a capsule inserted at one time, to be pierced at a later time thus maintaining the freshness of the coffee inside the capsule until time to brew. This timer function can be achieved for a single or multi-capsule arrangement.

In accordance with another aspect, a beverage making machine includes a drawer assembly having a housing having at least a one track on an inner side thereof, a platform located within the housing for receiving a capsule puncturing needle, and a drawer. The drawer includes least one capsule receptacle therein, slidably engaged with the track of the housing. The beverage making machine includes a brew timer operatively connected to the drawer assembly for triggering a change in a vertical distance between a top surface of the drawer and a lower surface of the platform at a desired time.

In accordance with another aspect, a method of operating drawer assembly for a capsule based brewing machine includes translating a drawer along a track of a housing from an extracted position to an inserted position, changing a vertical distance between a top surface of the drawer and a lower surface of a platform, and puncturing a capsule with a puncturing needle.

In some embodiments, changing the vertical distance between the top surface of the drawer and the lower surface of the platform can include changing the vertical distance as the drawer moves from the extracted position to the inserted position. In some embodiments, changing the vertical distance between the top surface of the drawer and the lower surface of the platform can include changing the vertical distance after the drawer moves from the extracted position to the inserted position. Changing the vertical distance between the top surface of the drawer and the lower surface of the platform can include moving the platform vertically with respect to the drawer as the drawer moves from the extracted position to the inserted position. Changing the vertical distance between the top surface of the drawer and the lower surface of the platform can include moving the drawer vertically with respect to the platform as the drawer moves from the extracted position to the inserted position.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1A is a perspective view of an embodiment of a drawer assembly constructed in accordance with the present disclosure, showing a drawer with a single capsule receptacle for receiving an ingredient capsule for beverage brewing;

FIG. 1B is a set of perspective views of the head assembly of the drawer assembly of FIG. 1A, showing a needle and a seal of a platform for covering the single capsule receptacle of the drawer;

FIG. 1C is a front elevation view of the drawer assembly of FIG. 1A, showing a biasing spring used to provide the downward force to the needle and seal of the heat assembly;

FIG. 2A is a perspective view of another embodiment of a drawer assembly constructed in accordance with the present disclosure, showing a drawer with two capsule receptacles for receiving respective ingredient capsules for beverage brewing;

FIG. 2B is a set of perspective views of the head assembly of the drawer assembly of FIG. 2A, showing a pair of needles and a pair of seals of a platform for covering the two capsule receptacles of the drawer;

FIG. 2C is a front elevation view of the drawer assembly of FIG. 2A, showing a biasing spring used to provide the downward force to the needles and seals of the heat assembly;

FIG. 3 is a cross-sectional view of the drawer assembly of FIG. 1A, showing the drawer locked in a brewing position;

FIG. 4A is a perspective view of another embodiment of a drawer assembly constructed in accordance with the present disclosure, showing two independent drawers each with a respective capsule receptacle and two independent head assemblies with both drawers in the open position;

FIG. 4B is a perspective view of the drawer assembly of FIG. 4A, showing both drawers in the closed position with both head assemblies down;

FIG. 4C is a perspective view of the drawer assembly of FIG. 4A, showing the left drawer in the closed position with the left head assembly down;

FIG. 4D is a perspective view of the drawer assembly of FIG. 4A, showing the right drawer in the closed position with the right head assembly down;

FIG. 5A is a cross-sectional view of a portion of a conventional capsule receptacle system, showing a conventional seal used with conventional capsule based brewing machines which can often lead to tearing or inward buckling of capsule foil;

FIG. 5B. is an enlarged cross-sectional view of a portion of the drawer assembly of either FIG. 1A or 2A, showing an outer seal of the head assembly applying even pressure around the outer rim of the capsule;

FIG. 6 is a set of cross-sectional views of the drawer assembly of FIG. 1A, showing vertical movement of the head assembly as the drawer is pulled outward;

FIG. 7A is a perspective view of another embodiment of a drawer assembly constructed in accordance with the present disclosure, showing a drawer having a single capsule receptacle and the housing having at least one guide slot for guiding at least one guide pin extending from the drawer;

FIG. 7B is a perspective view of the drawer of the drawer assembly of FIG. 7A, showing the drawer with at least one guide pin extending therefrom;

FIG. 8A is a perspective view of another embodiment of a drawer assembly constructed in accordance with the present disclosure, showing a drawer having a plurality of capsule receptacles and the housing having at least one guide slot for guiding at least one guide pin extending from the drawer;

FIG. 8B is a perspective view of the drawer of the drawer assembly of FIG. 8A, showing the drawer with at least one guide pin extending therefrom;

FIG. 9A is a perspective view of another embodiment of a drawer assembly constructed in accordance with the present disclosure, showing a drawer having a single capsule receptacle and the housing having a plurality of guide slots for guiding a plurality of guide pins extending from the drawer;

FIG. 9B is a perspective view of the drawer of the drawer assembly of FIG. 9A, showing the drawer with a plurality of guide pins extending therefrom;

FIG. 10 is an isometric view of an interior of the drawer of FIG. 9A with a front of the drawer cut-away to show the interior of the drawer, showing a biasing spring integrated into the drawer;

FIG. 11 is a cross-sectional view of the drawer assembly of FIG. 9A, showing the drawer locked into a brewing position, showing an outer seal applying even pressure around the outer rim of the capsule to prevent buckling or tearing of capsule foil due to needle insertion;

FIG. 12 is a set of cross-sectional views of the drawer assembly of FIG. 9A, showing vertical movement of the drawer as the drawer is pushed inward;

FIG. 13A is a perspective view of another embodiment of a drawer assembly constructed in accordance with the present disclosure, showing a gear interface between the head assembly and the drawer, where the drawer has a plurality of capsule receptacles;

FIG. 13B is a perspective view of a portion of the drawer assembly of FIG. 13A, showing a double pinion gear driving the head assembly vertically and driving the drawer horizontally with a single motor;

FIG. 14 is a perspective view of another embodiment of a drawer assembly constructed in accordance with the present disclosure, showing a gear interface between the head assembly and the drawer, where the drawer has a single capsule receptacle;

FIG. 15 is a perspective view of a portion of the drawer assembly of FIG. 13A, showing the double pinion gear;

FIG. 16 is a set of cross-sectional views of the drawer assembly of FIG. 13A, showing the vertical movement of the head assembly and the outward horizontal movement of the drawer as the double pinion gear rotates;

FIG. 17A is a perspective view of another embodiment of a drawer assembly constructed in accordance with the present disclosure, showing a single drawer with two capsule receptacles and two independent head assemblies with the drawer in the open position;

FIG. 17B is a perspective view of the drawer assembly of FIG. 17A, showing the drawer in the closed position;

FIG. 17C is a perspective view of the drawer assembly of FIG. 17A, showing the drawer in the closed position with a left head assembly down;

FIG. 17D is a perspective view of the drawer assembly of FIG. 17A, showing the drawer in the closed position with a right head assembly down;

FIG. 17E is a perspective view of the drawer assembly of FIG. 17A, showing the drawer in the closed position with a right head assembly down;

FIG. 18A is a perspective view of another embodiment of a drawer assembly constructed in accordance with the present disclosure, showing two independent drawers each with a respective capsule receptacle and two independent head assemblies with both drawers in the open position;

FIG. 18B is a perspective view of the drawer assembly of FIG. 18A, showing both drawers in the closed position;

FIG. 18C is a perspective view of the drawer assembly of FIG. 18A, showing both drawers in the closed position with both head assemblies down;

FIG. 18D is a perspective view of the drawer assembly of FIG. 18A, showing both drawers in the closed position with the left head assembly down;

FIG. 18E is a perspective view of the drawer assembly of FIG. 18A, showing both drawers in the closed position with the right head assembly down;

FIG. 18F is a perspective view of the drawer assembly of FIG. 18A, showing the left drawer in the closed position;

FIG. 18G is a perspective view of the drawer assembly of FIG. 18A, showing the left drawer in the closed position with a left head assembly down;

FIG. 18H is a perspective view of the drawer assembly of FIG. 18A, showing the right drawer in the closed position;

FIG. 18I is a perspective view of the drawer assembly of FIG. 18A, showing the right drawer in the closed position with the right head assembly down;

FIG. 19 is a perspective view of an embodiment of a beverage making device constructed in accordance with the present disclosure, showing a drawer assembly; and

FIG. 20 is an enlarged perspective view of a portion of the beverage making device of FIG. 19, showing the user interface and timer input.

### DETAILED DESCRIPTION

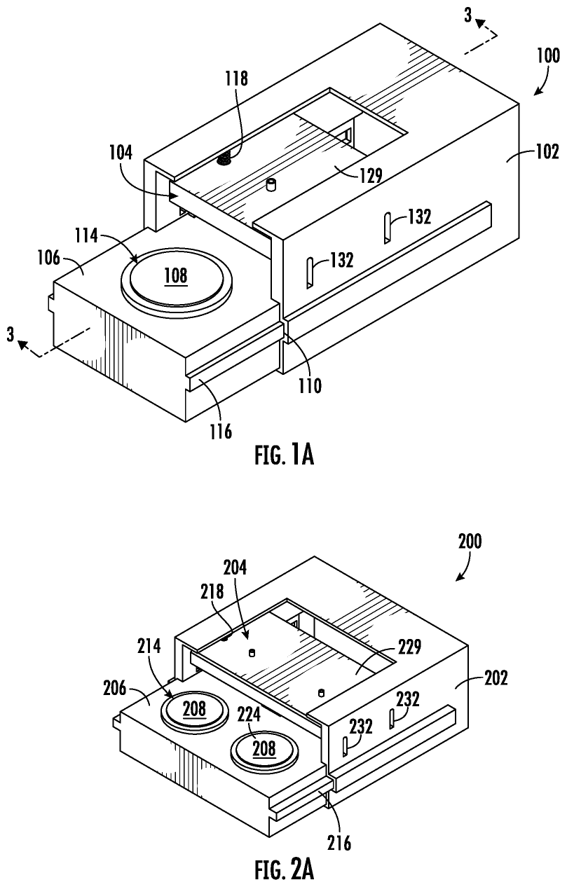

Reference will now be made to the drawings wherein like reference numerals identify similar structural features or aspects of the subject disclosure. For purposes of explanation and illustration, and not limitation, a partial view of an exemplary embodiment of a drawer assembly for use in a pod or capsule beverage making system in accordance with the disclosure is shown in FIGS. 1A and 1s designated generally by reference character 100. Other embodiments of the drawer assembly of the present disclosure, or aspects thereof, are provided in FIGS. 1B-20, as will be described. The system can be used to allow a user to insert the pod or capsule in an upright position, while not changing the height of the maker during open and closed positions. Given the restricted height beneath kitchen cabinets and the like, embodiments of the present disclosure avoid the need for free vertical space above the beverage maker as seen in conventional, top-loading beverage makers, meaning that it can be placed underneath kitchen cabinets without needing to pull the beverage maker out for use.

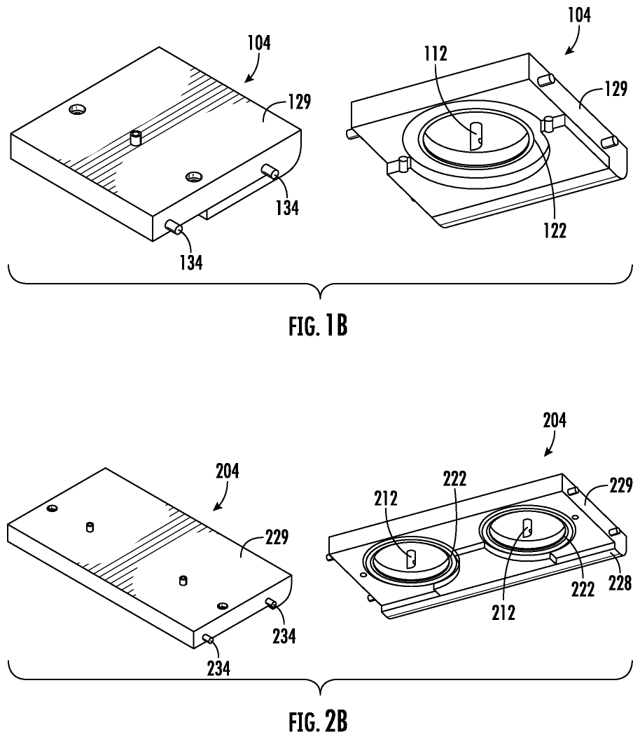

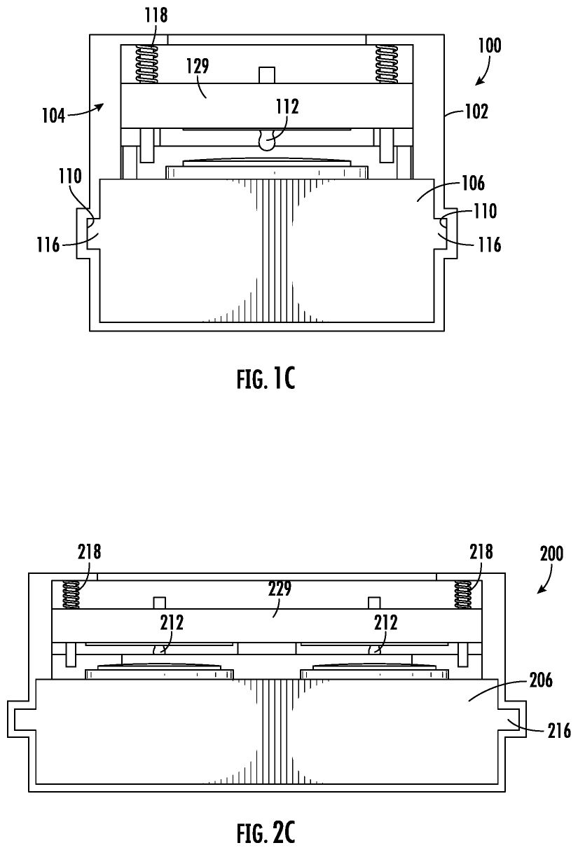

As shown in FIGS. 1A-1C, a drawer assembly 100 is a front-loading mechanism including a housing 102, a head assembly 104 and a drawer 106. Drawer 106 includes a capsule receptacle 114 therein. Drawer 106 is configured and adapted to move horizontally outward to allow a beverage capsule 108 to be loaded within capsule receptacle 114. Those skilled in the art will appreciate that drawer 106 can load one or multiple beverage capsules (multiple capsules shown in FIGS. 2A-2C). Housing 102 includes a track 110 defined on an inner side thereof. Drawer 106 is slidably engaged with track 110 of the housing via mating protrusions 116 on each side of drawer 106. Head assembly 104 is located within housing 102 and includes a platform 129, a capsule puncturing needle 112 and an outer seal ring 122. Housing 102 includes guide slots 132 and head assembly 104 includes guide pins 134 positioned within respective guide slots 132. Guide pins 134 are configured and adapted to move vertically within their respective guide slots 132 as head assembly 104 is moved upwards and downwards, described below.

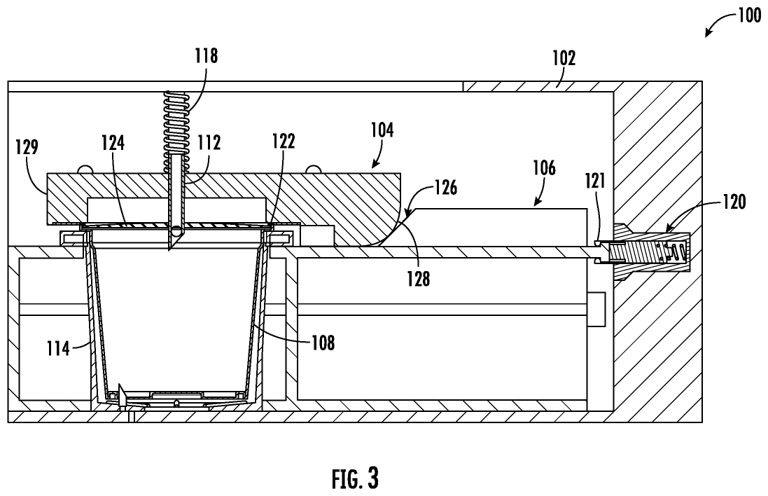

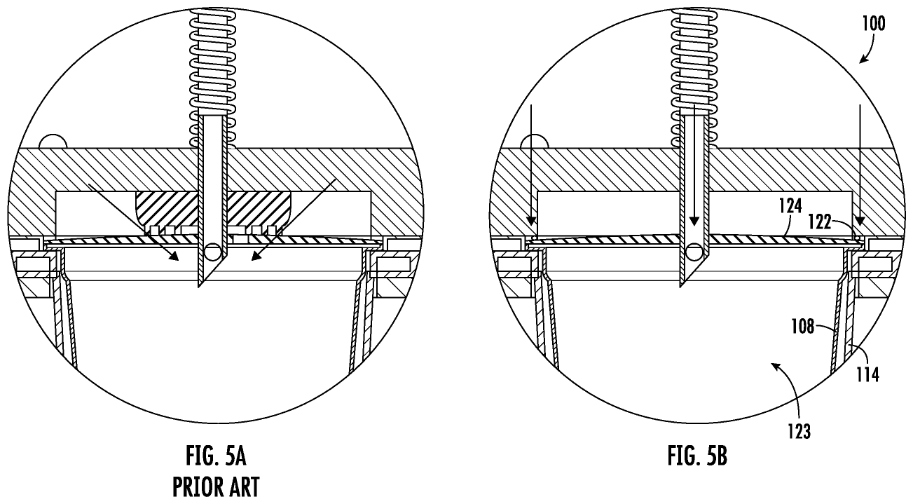

With reference now to FIGS. 3 and 5B, drawer assembly 100 includes biasing springs 118 to provide the downward force on head assembly 104 as drawer 106 is pushed inwards to assist with the vertical piercing action of the capsule puncturing needle 112. Drawer assembly 100 includes a spring-loaded push latch 120 to lock the drawer 106 into a brewing position. Current top-loading beverage capsule makers can be prone to spraying hot water if the lid is opened during the brewing cycle. The drawer-type action of this design, combined with the spring-loaded push-latch 120 mitigates the risk of hot water spray as compared with conventional top-loading beverage makers. As drawer 106 is pushed inward, biasing springs 118 (consisting of one or multiple springs) assists with the vertical piercing action of a capsule foil 124. Conventional top-loading beverage making systems can require a substantial amount of user force to close to lid and pierce the foil. Because drawer assembly 100 uses a spring-assisted puncture mechanism, user effort is reduced. FIG. 3 shows drawer 106 locked in the brewing position. Note here that needle 112 has pierced foil 124 to allow for liquid inflow. Push-latch 120 is shown locked. Those skilled in the art will readily appreciate that pushing drawer 106 slightly inwards will unlock arms 121 of latch 120 and allow drawer 106 to move outwards.

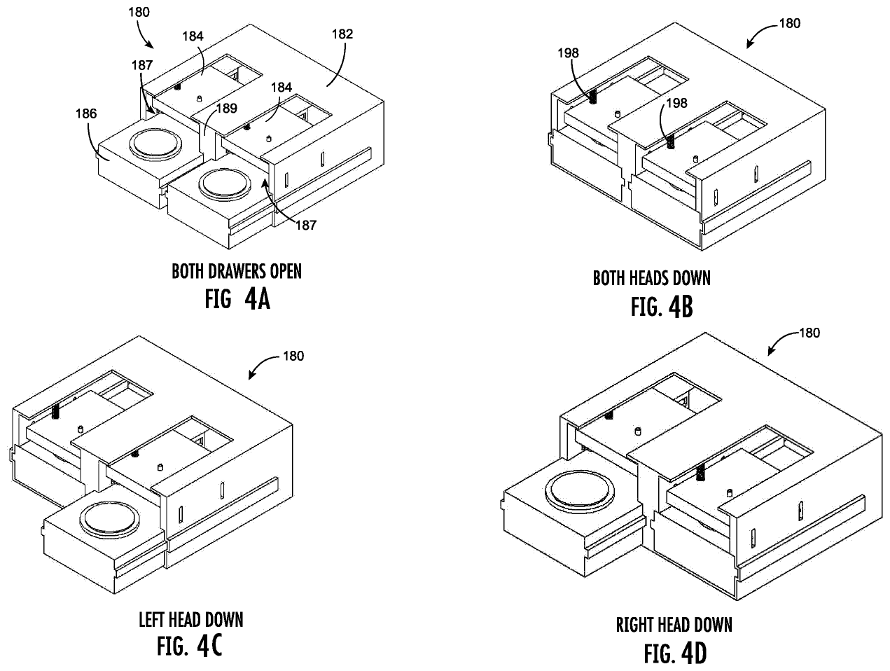

With continued reference to FIGS. 3 and 5B, when in the brewing position, outer sealing ring 122 of head assembly 104 seals against the outer peripheral wall of the beverage capsule (as opposed to conventional beverage capsule makers, see FIG. 5A, which seal in a central area, against the foil itself). FIG. 4 shows the conventional seal that is used with capsule beverage brewers currently. By applying force directly to the center of the capsule foil, like in FIG. 5A, it can often lead to tearing or inward buckling of the foil, causing an improper puncture and seal.

As shown in FIG. 5B, in embodiments of the present disclosure, the peripheral seal of outer sealing ring 122, e.g. an o-ring seal, or the like, prevents and/or mitigates tearing and buckling of a capsule foil 124, ensuring a proper puncture and more consistent brewing. By applying even pressure around the outer rim of capsule 108, shown schematically by downward arrows in FIG. 5B, it is better ensured that the foil stays taut and that the force applied by needle 112 to foil 124 will not cause foil 124 to buckle inwards or tear foil 124 as it pierces. Proper sealing of a brewing chamber 123 of capsule 108 leads to more consistent brewing across different capsule manufacturers. Drawer 106 includes a ramp element 126, e.g., a sloped surface, in abutment with a lower surface 128 of platform 129. The abutment of ramp element 126 with lower surface 128 acts to vertically raise or lower head assembly 104 as drawer 106 translates horizontally.

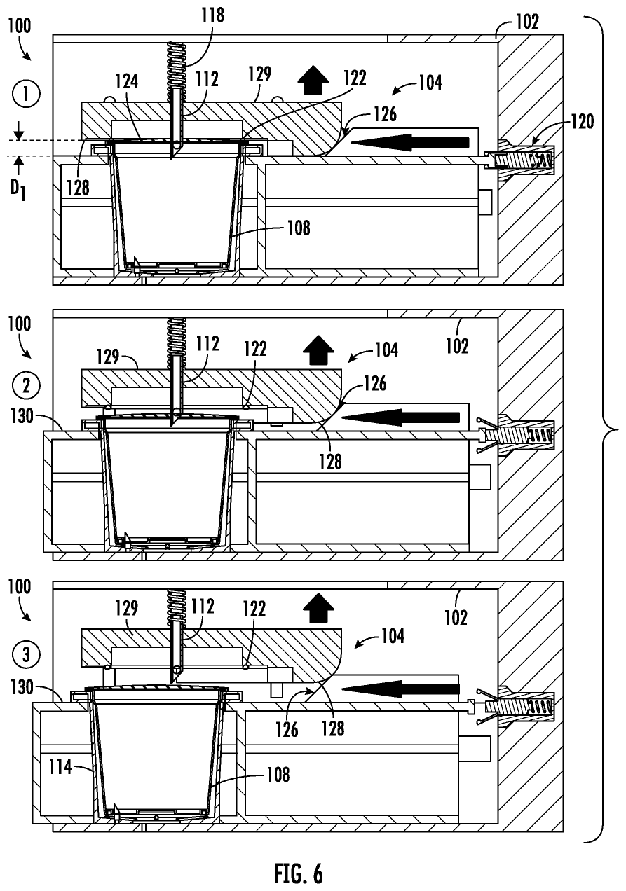

With reference now to FIG. 6, drawer assembly 100 has and an inserted positon (1) and an extracted position (3). In inserted position (1), drawer 106 is engaged with spring-loaded push latch 120 and head assembly 104 (including platform 129, needle 112 and seal 122) is biased downward by biasing springs 118. In this inserted position, the needle 112 has punctured the foil 124 of capsule 108 allowing fluid flow through needle 112 into capsule 108 for brewing an ingredient within capsule 108, e.g. coffee, tea, or the like, to generate a beverage. As drawer 106 is pulled outward, ramp element 126 pushes head assembly 104 upward, compressing the springs 118 and disengaging needle 112 and seal 122. In an intermediate position (2), drawer 106 is released from spring-loaded push latch 120 and is translating horizontally to the left (as oriented in FIG. 6). In this position, ramp element 126 is engaging lower surface 128 and forcing biasing springs 118 in the upwards direction, e.g. compressing biasing spring 118, and raising head assembly 124 and its needle 112. A vertical distance Di between a top surface 130 of the drawer and lower surface 128 of a platform 129 of the head assembly changes as drawer 106 moves between the extracted position (3) to the inserted position (1), and vice a versa. In the extracted position (3), needle 112 has been extracted fully out of capsule 108 and drawer 106 is allowed to be further translated out of housing 102 for, as an example, removal of the punctured capsule and replacement with a new capsule. After the new capsule is loaded, drawer 106 is then pushed inward as the head assembly 104 is simultaneously forced downward by springs 118, piercing foil of the new capsule and creating a seal before initiating brewing.

As shown in FIGS. 2A-2C, another embodiment of a drawer assembly 200 is a front-loading mechanism including a housing 202, a head assembly 204 and a drawer 206. Drawer 206 is the same as drawer 106 except that drawer 206 includes a plurality of capsule receptacles 214 therein. Drawer 206 is configured and adapted to move the same as drawer 106 to allow a beverage capsule 208 to be loaded. Housing 202 includes a track 210, which is the same as track 110. Drawer 206 is engaged with track 210 via mating protrusions 216, the same as drawer 106. Head assembly 204 is the same as head assembly 104 except that it includes a plurality of puncturing needles 212 and respective seals 222. Housing 202 includes guide slots 232 and head assembly 204 includes guide pins 234 positioned within respective guide slots 232. Guide pins 234 are the same as guide pins 134 are configured and adapted to move in the same manner. Drawer assembly 200 includes biasing springs 218, the same as drawer assembly 100 to assist with the vertical piercing action of the capsule puncturing needle 212.

While cross-sectional views of FIGS. 3, 5B and 6, are labeled designating drawer assembly 100, the figures readily represent the same aspects of drawer assembly 200. Drawer assembly 200 includes a spring-loaded push latch, e.g., spring-loaded push 120, to lock the drawer 206 into a brewing position. As drawer 206 is pushed inward, biasing springs 218 (consisting of one or multiple springs) assist with the vertical piercing action of a capsule foil 224, in the same way as it is shown for springs 118 of drawer assembly 100 in FIG. 3 and FIG. 6. Outer sealing ring 222 of head assembly 204 seals against the outer peripheral wall of the beverage capsule in the same way as outer sealing ring 122, ensuring a proper puncture and more consistent brewing. Drawer 206 includes a ramp element, e.g., the same as ramp element 126, that acts to abut with a lower surface 228 of head assembly 204. This abutment acts to vertically raise or lower head assembly 204 as drawer 206 translates horizontally in the same manner as shown in FIG. 6 for drawer assembly 100.

As shown in FIGS. 4A-4D, in another embodiment of a drawer assembly 180, drawer assembly 180 includes two separately movable drawers 186 and two separate head assemblies 184. Each drawer 186 is essentially the same as drawer 106. Each head assembly 184 is the same as head assembly 104. The primary difference between drawer assembly 180 and drawer assembly 100 is that a housing 182 of drawer assembly 180 has two openings 187 for receiving two separate drawers 186. The openings 187 are divided by a wall 189. Otherwise, housing 182 is largely the same as that of housing 102 of FIG. 1A. Drawer assembly 180 includes a push latch (the same as push latch 120), biasing springs 198, the same as biasing springs 118, and other components of drawer assembly 100. Because drawers 186 and head assemblies 184 are separately movable, you could insert two different capsules at two different times and have separate brewing functions associated with each capsule. For example, as shown in FIG. 4C or 4D, you could have one side (left or right side) brewing, while another capsule can be input to begin brewing afterwards.

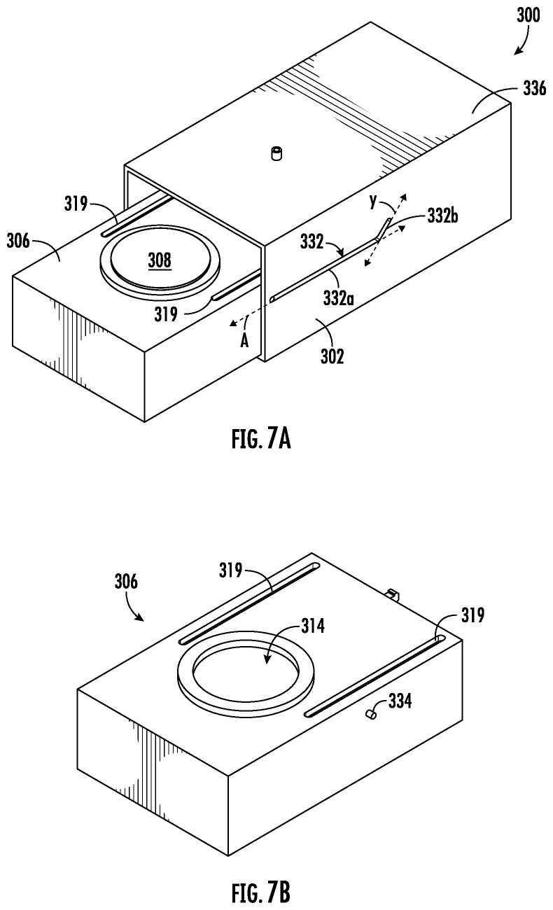

As shown in FIGS. 7A-7B and 10-12, another embodiment of a drawer assembly 300 is shown. Drawer assembly 300 is a front-loading mechanism including a housing 302, a platform 329 and a drawer 306. Drawer assembly 300 is similar to drawer assembly 100 in that it is front-loading. In drawer assembly 300, however, assembly 302 only has a single moving part, drawer 306. Drawer 306 is configured and adapted to move vertically with respect to platform 329 as drawer 306 moves from the extracted position to the inserted position. In this case, platform 329 is stationary and is built into housing 302. Drawer assembly 300 includes a capsule puncturing needle 312 positioned through platform 329 and an outer seal ring 322 mounted on platform 329.

With continued reference to FIGS. 7A-7B and 10-12, drawer 306 includes a capsule receptacle 314 defined therein. Drawer 306 is configured and adapted to move horizontally outward to allow a beverage capsule 308 to be loaded within capsule receptacle 314. Those skilled in the art will appreciate that drawer 306 can load one or multiple beverage capsules (multiple capsules shown in FIGS. 8A-8B). Drawer 306 includes guide pins 334 (one on each longitudinal side of drawer 306) configured and adapted to engage with a tracks 332 of housing 302. There is a track 332 on each longitudinal side of housing 302. In assembly 300, tracks 332 of housing 302, e.g., a guide slots, each include a first section 332a defining a first longitudinal axis A in a first direction and a second section 332b defining a second longitudinal axis Y in a second direction. The second direction is at an angle relative to the first direction. Second section 332b is angled upwards at a slight incline toward a top surface 336 of housing 302 and towards platform 329 such that, as drawer 306 moves from the extracted position and the inserted position, tracks 332 guide drawer 306, towards the platform, upward into needle 312 and seal. As shown in FIGS. 7A-7B and 10-12, drawer 306 includes longitudinal spring guide slots 319. Drawer assembly 300 includes biasing springs 318 operatively coupled to housing 302 by way of spring posts 338 and washers 340. Spring posts 338 extend down from platform 329 through spring guide slots 319 in drawer 306. Spring guide slots 319 allow for drawer 306 to slide along spring posts 338. Springs 318 are mounted onto stationary spring posts 338 on an underside of drawer upper wall 342. Respective washers 340 are positioned around each spring post 338 between upper wall 342 and springs 318. Washers 340 are configured and adapted to translate vertically downward along spring posts 338 when drawer 306 is in first section of track 332a. This vertical downward movement acts to compress springs 318 and washers 40 maintain contact with drawer 306 throughout its movement. Upon reaching the incline in the side slots, springs 338 push drawer 306 upwards into needle 312 and seal 322. Those skilled in the art will readily appreciate that similar to drawer assembly 180, drawer assembly 300 could also be made into a double drawer assembly with two separately movable drawers similar to drawer 306 with a larger divided housing, similar to housing 302, to accommodate the two drawers 306.

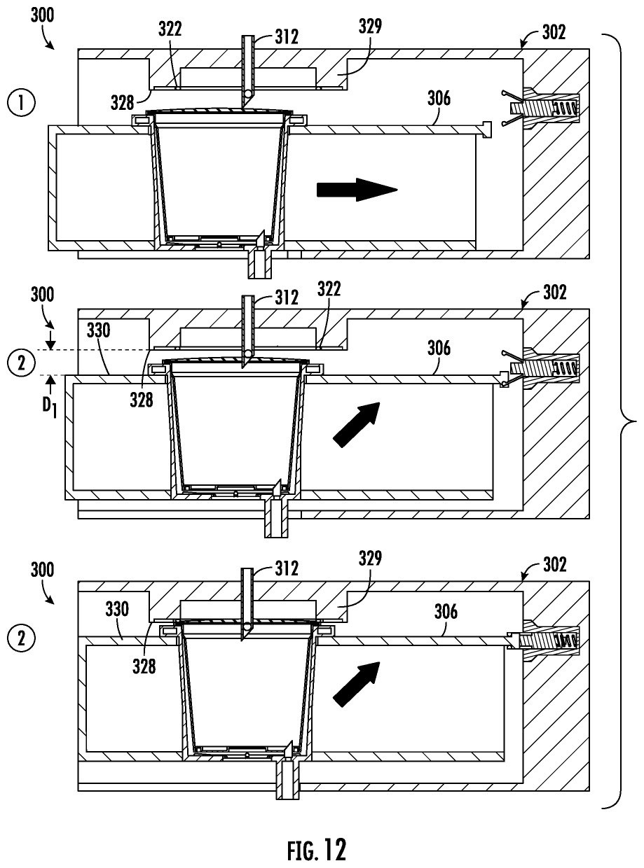

With reference now to FIGS. 11-12, FIG. 11 shows drawer 306 locked in a brewing position. In the locked brewing position, seal 322 is compressed against an outer peripheral wall of capsule 308 and drawer 306 is engaged with a push latch 320 of housing 302 (similar to push latch 120) and its respective arms 321. Seal 322 is the same as seal 122, described above, and acts to prevent buckling or tearing of foil 324 as needle 312 punctures. FIG. 12 shows the movement of drawer 306 as it moves along tracks 332. Tracks 332 (e.g., guide slots) are used to assist with the diagonal segment of the motion, piercing of the capsule foil 324 and mating of the sealing surfaces. Drawer assembly 300 has and an extracted position (1) an inserted positon (3). In the extracted position (1), needle 312 is extracted fully out of capsule 308 and drawer 306 is allowed to be further translated out of housing 302 for, as an example, removal of the punctured capsule and replacement with a new capsule. After a capsule is loaded, drawer 306 is then pushed inward. In intermediate position (2), drawer 306 is pushed inward and is guided up the inclined portion of track 332, de-compressing the springs 318 and engaging needle 312 and seal 322. A vertical distance Di between a top surface 330 of the drawer and lower surface 328 of a platform 329 changes as drawer 306 moves between the extracted position (1) to the inserted position (3), and vice a versa. In inserted position (3), drawer 306 is engaged with spring-loaded push latch 320. In this inserted position, the needle 312 has punctured the foil 324 of capsule 308 allowing fluid flow through needle 312 into capsule 308 for brewing an ingredient within capsule 308, e.g. coffee, tea, or the like, to generate a beverage.

As shown in FIGS. 8A-8B, another embodiment of a drawer assembly 400 is a front-loading mechanism including a housing 402, and a drawer 406. Drawer 406 is the same as drawer 306 except that drawer 406 includes a plurality of capsule receptacles 414 therein. Drawer 406 is configured and adapted to move the same as drawer 306 to allow a beverage capsule 408 to be loaded. Housing 402 includes tracks 432, e.g., a guide slots, each including a first section 432a and second section 432b. Tracks 432 are the same as tracks 332. Drawer 406 includes guide pins 434 (one on each longitudinal side of drawer 406) configured and adapted to engage with a tracks 432 of housing 402. There is a track 432 on each longitudinal side of housing 402.

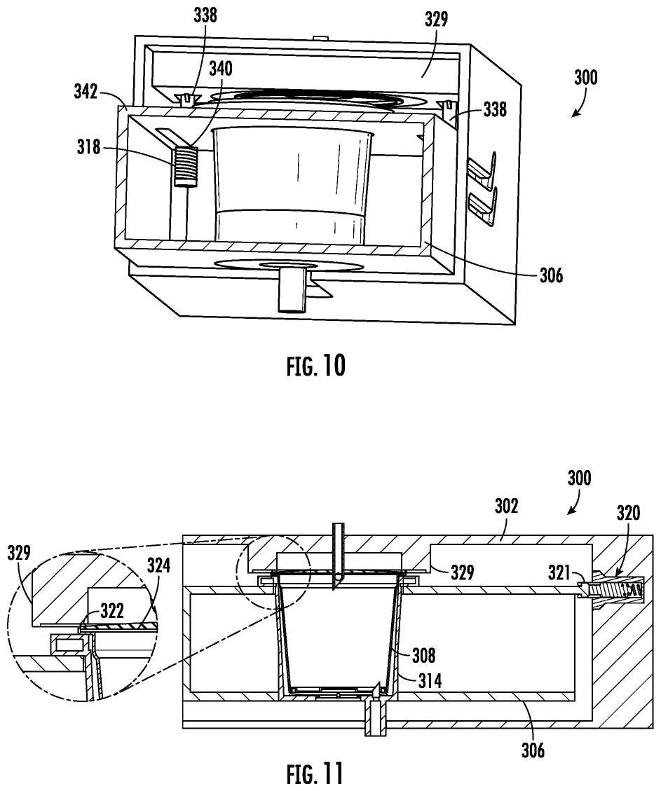

With continued reference to FIGS. 8A-8B, drawer 406 includes longitudinal spring guide slots 419, which are the same as spring guide slots 319. While the perspective view of FIG. 10 and the cross-sectional views of FIGS. 11-12 are labeled designating drawer assembly 300, the figures readily represent the same aspects of drawer assembly 400. Drawer assembly 400 includes a spring-loaded push latch, e.g., spring-loaded push 320, to lock the drawer 406 into a brewing position. Drawer assembly 400 includes biasing springs, e.g., the same as biasing springs 318, operatively coupled to housing 402 by way of spring posts, e.g., spring posts 338, and washers, e.g. washers 340. As drawer 406 is pushed inward spring guide slots 419 slide along the spring posts and biasing springs, e.g. biasing springs 318, assist with the vertical piercing action of a capsule foil 424, in the same way as it is shown for springs 318 of drawer assembly 300 in FIGS. 10-12. Drawer assembly 400 includes an outer sealing ring, e.g. outer sealing ring 322, to seal against the outer peripheral wall of beverage capsule 408 in the same way capsule 308 is sealed, ensuring a proper puncture and more consistent brewing.

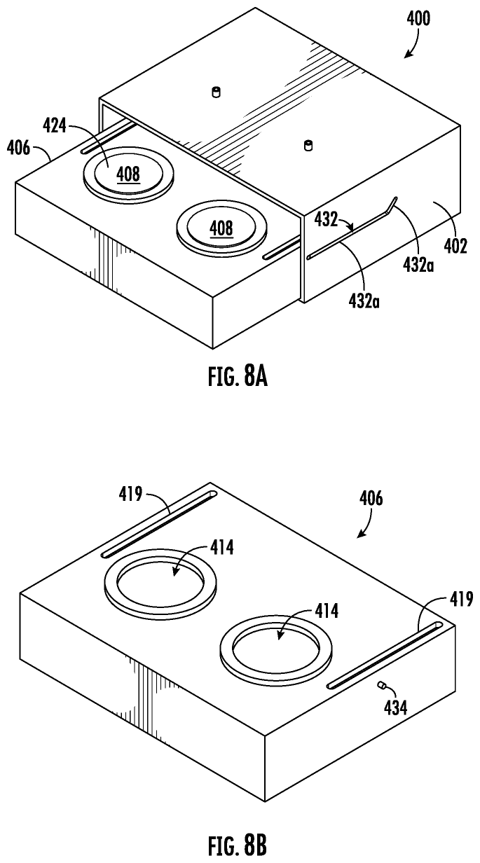

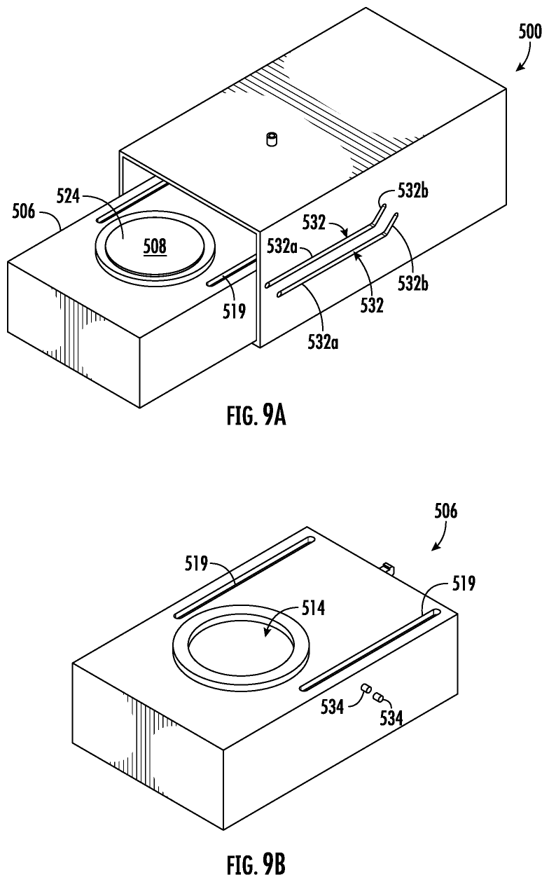

As shown in FIGS. 9A-9B, another embodiment of a drawer assembly 500 is a front-loading mechanism including a housing 502 and a drawer 506. Housing 502 is the same as housing 302 except that housing 502 includes a plurality of tracks 532, e.g., a guide slots, on each side of housing 502. There are two tracks 532 on each longitudinal side of housing 502. Drawer 506 is the same as drawer 306 except that drawer 506 includes a plurality of respective guide pins 534 on each side of drawer 506. Multiple tracks 532 on each side of housing 502 and multiple guide pins 534 on each side of drawer 506 are used to prevent or reduce tilting or wobbling thereby acting to stabilize drawer 506 as it moves. Stabilization of drawer 506 acts to ensure proper alignment of capsule foil 524 with the needle, minimizing the size of the puncture hole as the needle pierces, and ensuring proper sealing of the brewing chamber. Drawer 506 is configured and adapted to move the same as drawer 306 to allow a beverage capsule 508 to be loaded. Each track 532 includes a first section 532a and second section 532b, the same as first section 332a and second section 332b. Drawer 506 includes longitudinal spring guide slots 519, which are the same as spring guide slots 319. While the perspective view of FIG. 10 and the cross-sectional views of FIGS. 11-12 are labeled designating drawer assembly 300, the figures readily represent the same aspects of drawer assembly 500. Those skilled in the art will readily appreciate that similar to drawer assembly 180, drawer assembly 500 could also be made into a double drawer assembly with two separately movable drawers similar to drawer 506 with a larger divided housing, similar to housing 502, to accommodate the two drawers 506.

As shown in FIGS. 13A-13B, another embodiment of a drawer assembly 700 is a front-loading mechanism including a housing 702, a head assembly 704 and a drawer 706. Drawer assembly 700 includes a gear interface 743 between head assembly 704 and drawer 706. Drawer 706 is the same as drawer 106 except that drawer 706 includes a first rack gear 744 as part of the gear interface 743 to allow for motorized horizontal movement of drawer 706. Housing 702 includes a track 710, which is the same as track 110. Drawer 706 is engaged with track 710 via mating protrusions 716, the same as drawer 106. Head assembly 704 includes a platform 729. Head assembly 704 is the same as head assembly 104 except that it includes a plurality of puncturing needles 712 and a second rack gear 746 for motorized vertical movement of platform 729. Housing 702 includes guide slots 732 and head assembly 704 includes guide pins 734 positioned within respective guide slots 732. Guide pins 734 are the same as guide pins 134 and are configured and adapted to move in the same manner. Instead of biasing springs 118 and a sloped element, e.g. ramp element 126, drawer assembly 700 includes gear interface 743 and electric motor 748.

With reference now to FIGS. 13A-13B and 15-16, gear interface 743 includes a double pinion gear 750, first rack gear 744 and second rack gear 746. First rack gear 744 is operatively connected to drawer 706 for common movement therewith. Second rack gear 746 is operatively connected to platform 729 of head assembly 704 for common movement therewith. Double pinion gear 750 includes two sets of offset gear teeth such that the system can perform two separate motions with a single rotation of gear 750. A first set of teeth 752 is configure and adapted to be meshed with first rack gear 744 and a second set of teeth 754 is configured and adapted to be meshed with second rack gear 746 such that rotation of the pinion gear 750 is configured and adapted to drive horizontal translation of first rack gear 744 or vertical translation of second rack gear 746. Second set of teeth 754 is offset from first set of teeth 752 along a common rotation axis Z. First set of teeth 752 does not extend around the full circumference of pinion gear 750, such that vertical movement of second rack gear 746 (on platform 729) may occur without having horizontal translation of first rack gear 744 (on drawer 706). Second set of teeth 754 does not extend around the full circumference of pinion gear 750, such that horizontal movement of first rack gear 744 (on drawer 706) may occur without having vertical translation of second rack gear 746 (on platform 729). In other words, the double pinion gear 750 will only ever be meshed (in contact) with one rack gear at a time, actuating two separate mechanisms in a single rotation.

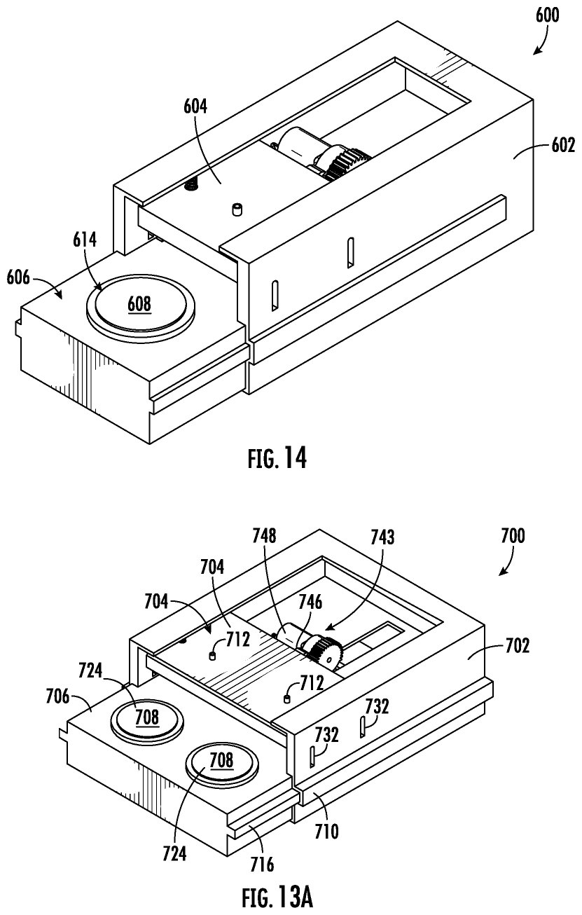

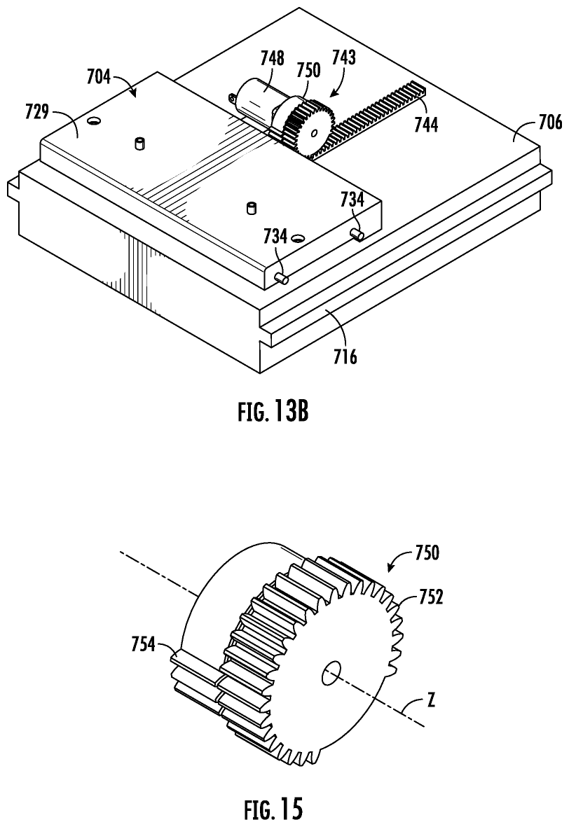

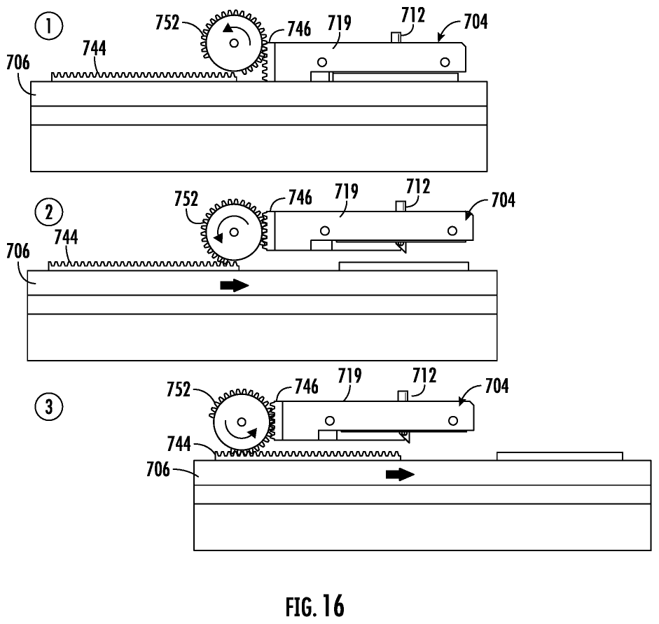

As shown in FIGS. 13A-13B and 15-16, drawer assembly 700 includes electric motor 748 coupled to double pinion gear 750 to drive rotation thereof and automate the movement of the head assembly 704 and drawer 706, requiring no physical user input. Double pinion gear 750 drives the head assembly 704 vertically, the drawer 706 horizontally Drawer assembly 700 offers several advantages, including a fully automated motion with no user input, precise alignment of mating surfaces, and does not include a biasing spring that could wear over time. The motion of the gear train as motor 748 turns is shown in FIG. 16. In an inserted position (1) of FIG. 16, head assembly 704 is down and needle 712 has punctured at least one capsule 708 and created a seal. Fluid flow through needle 712 into capsule 708 allows for brewing an ingredient within capsule 708, e.g. coffee, tea, or the like, to generate a beverage. Those skilled in the art will readily appreciate that the seal can be a similar peripheral seal as sealing ring 122. After brewing is complete, second set of teeth 754 on gear 750 mesh with the second rack gear 746 on the head assembly 704 and begin to move it upward into an intermediate position (2). In an intermediate position (2) of FIG. 16, the upwards motion of second rack gear 746 is complete and first set of teeth 752 meshes with the first rack gear 744 on drawer 706, beginning its linear motion outwards (shown schematically by the right-hand arrow in FIG. 16). In an extracted position (3) of FIG. 16, drawer 706 is extended fully outwards for the unloading/loading of capsules 708. Once the ingredient capsules have been loaded, the motor turns in the opposite direction, completing the motion in reverse order.

With reference now to FIG. 14, another embodiment of a drawer assembly 600 is a front-loading mechanism including a housing 602, and a drawer 606. Drawer 606 and assembly 600 is the same as drawer 706 and assembly 700 except that drawer 606 includes a single capsule receptacle 614 therein, and housing 602 is narrower than housing 702 to accommodate the narrower drawer 606. Drawer 606 is configured and adapted to move the same as drawer 706 to allow a beverage capsule 608 to be loaded.

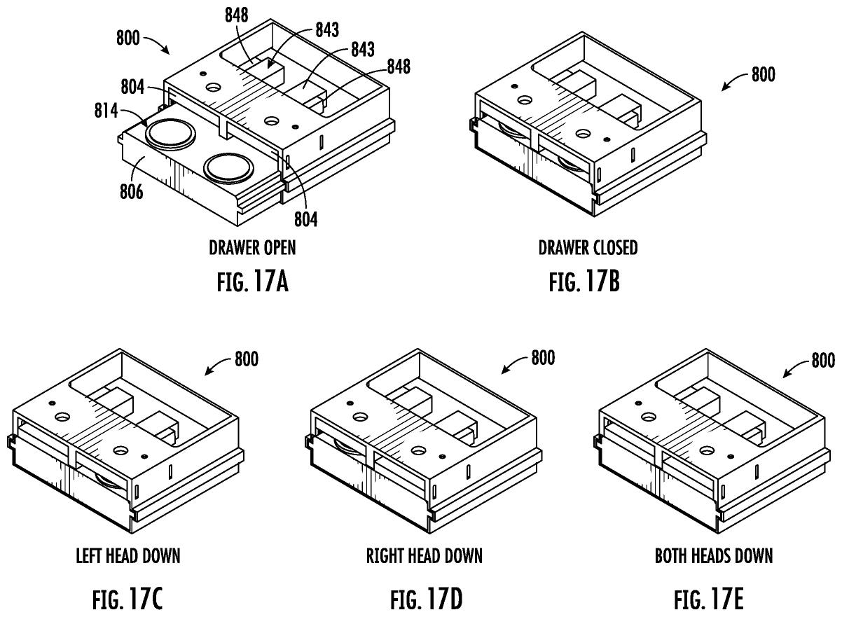

As shown in FIGS. 17A-17E, in another embodiment of a drawer assembly 800, drawer 806 is a single drawer having a plurality of capsule receptacles 814 defined therein. Drawer 806 is similar to drawer 706. Drawer assembly 800 is similar to drawer assembly 700 except that instead of a single head assembly 704, drawer assembly 800 includes two separately movable head assemblies 804. Because head assemblies 804 are separately movable, instead of having one gear interface 743 and one electric motor 748, like in assembly 700. Drawer assembly 800 includes two separate gear interfaces 843 and two separate electric motors 848. Each gear interface 843 is schematically shown in FIGS. 17A-17E, but each gear interface 843 is the same as gear interface 743. Each electric motor 848 is the same as electric motor 748. Those skilled in the art will readily appreciate that either of the electric motors 748 and gear interfaces 743 can move drawer 706 horizontally, but head assemblies 804 are moved vertically by their own respective gear interface 843 and electric motor 848.

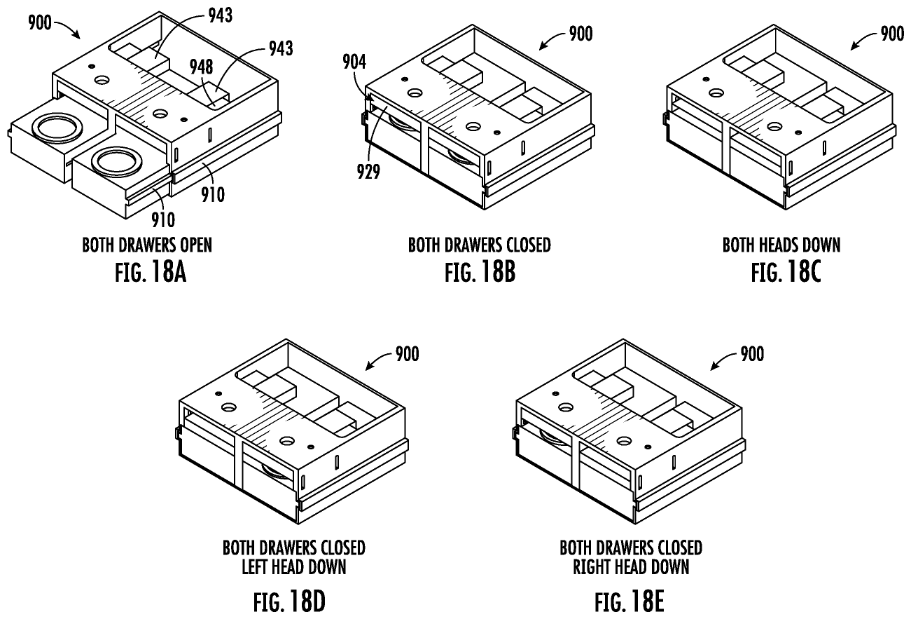

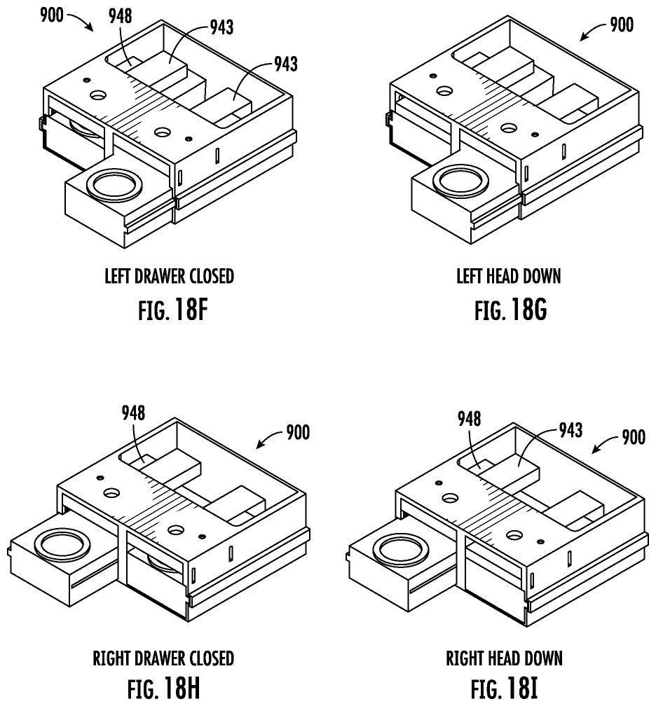

As shown in FIGS. 18A-181, in another embodiment of a drawer assembly 900, drawer assembly 900 includes two separately movable drawers 906 and two separate head assemblies 904. Each drawer 906 has a respective capsule receptacle 914 defined therein. Each drawer 906 is similar to drawer 606, except that instead of drawer 906 having mating protrusions on each side of drawer 906, drawer 906 includes a mating protrusion 916 only on one side of each drawer 906. Each mating protrusion 916 is engaged with a track 910. Each head assembly 904 includes a plurality of discretely movable platforms 929 and respective capsule puncturing needles, e.g. similar to needle 712.

With continued reference to FIGS. 18A-181, drawer assembly 900 includes two separate gear interfaces 943 and two separate electric motors 948. Each gear interface 943 is schematically shown in FIGS. 18A-181, but each gear interface 943 is the same as gear interface 743 (and includes a double pinion gear and two separate rack gears). Each electric motor 948 is the same as electric motor 748. Each drawer 906 and each head assembly 904 are moved horizontally and/or vertically by their own respective gear interface 943 and electric motor 948. The first rack gear can be operatively connected to the drawer for common movement therewith and the second rack gear can be operatively connected to a respective one of the discretely movable platforms for common movement therewith. The separate gear interfaces 943 and motors 948 enable use of discretely movable platforms. Those skilled in the art will readily appreciate that while two head assemblies 904 are shown, more than two head assemblies 904 and associated drawers 906 can be utilized.

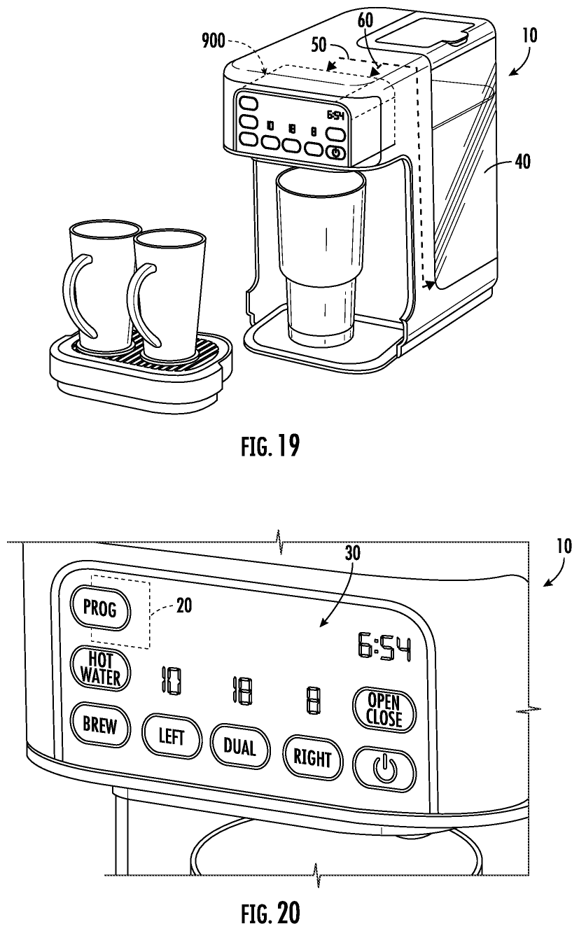

With reference now to FIGS. 19-20, a beverage making device 10 includes drawer assembly 900. Beverage making device 10 works by heating and subsequently dispensing the required volume of water to brew one or multiple beverage capsules, e.g. capsules 908. Beverage making device 10 includes a water reservoir 40, a first channel 50 for providing water from water reservoir 40 to a first receptacle, e.g., capsule receptacle 914, a second channel 60 in parallel with first channel 50 for providing water from water reservoir 40 to a second receptacle, e.g., second capsule receptacle 914. It is contemplated that a heating element is located between the water reservoir 40 and the first and second receptacles 914 for heating water to a desired temperature. It is also contemplated that in some embodiments, an assembly, having a check-valve and an air pump, is located between the water reservoir 40 and the heating element for flushing water back to water reservoir 40.

With continued reference to FIGS. 19-20, beverage making device 10 includes a brew timer 20 operatively coupled to drawer assembly 900 for triggering a change in a vertical distance between a top surface of the drawer and a lower surface of a platform, e.g. platform 929, at a desired time. This allows a capsule inserted at one time, to be pierced at a later time thus maintaining the freshness of the coffee inside the capsule until time to brew. This timer function can be achieved for a single or multi-capsule arrangement. Brew timer 20 is user programmable through a user interface 30 where different brewing timer durations can be selected for “left,” “right,” or “dual” receptacles 914. The independent nature of the drawers 906 and platforms 929 of drawer assembly 900 allows the drawer to be loaded and closed without puncturing the capsule/pod foil or bottom of pod. The time program is then set and the puncturing of the capsule foil occurs when brew time is set on the brew timer through user interface 30. The capsule can then be pierced at a later time thus maintaining the freshness of the coffee (or other ingredient) inside the capsule until time to brew. This timer function can be achieved for a single or multi-pod arrangement.

A method of operating drawer assembly, e.g. drawer assembly 100, 200, 300, 400, 500, 600, 700, 800 or 900, for a capsule based brewing machine, e.g. brewing machine 10, includes translating a drawer, e.g., drawer 106, 206, 306, 406, 506, 606, 706, 806 or 906, along a track of a housing, e.g., housing 102, 202, 302, 402, 502, 602, 702, 802, or 902, from an extracted position to an inserted position, changing a vertical distance between a top surface of the drawer and a lower surface of a platform, e.g. platform 129, 229, 329, 429, 529, 629, 729, 829 or 929, and puncturing a capsule with a puncturing needle, e.g., puncturing needle 112, 212, 312, 412, 512, 612, 712, 812 or 912.

In some embodiments, changing the vertical distance between the top surface of the drawer and the lower surface of the platform includes changing the vertical distance as the drawer moves from the extracted position to the inserted position. In some embodiments, changing the vertical distance between the top surface of the drawer and the lower surface of the platform includes changing the vertical distance after the drawer moves from the extracted position to the inserted position. In some embodiments, changing the vertical distance between the top surface of the drawer and the lower surface of the platform includes moving the head assembly vertically with respect to the drawer as the drawer moves from the extracted position to the inserted position. In some embodiments, changing the vertical distance between the top surface of the drawer and the lower surface of the platform includes moving the drawer vertically with respect to the head assembly as the drawer moves from the extracted position to the inserted position.

The methods and systems of the present disclosure, as described above and shown in the drawings, provide for a beverage maker that effectively produces a brewed beverage while allowing a user to insert the pod or capsule in an upright position, and also not change the height of the maker during open and closed positions. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A drawer assembly for a capsule based brewing machine comprising:
a housing having at least a one track on an inner side thereof;
a platform located within the housing for receiving a capsule puncturing needle; and
a drawer, having at least one capsule receptacle therein, slidably engaged with the track of the housing.

2. The drawer assembly of claim 1, wherein the drawer has an extracted position and an inserted positon, wherein a vertical distance between a top surface of the drawer and a lower surface of the platform changes as the drawer moves from the extracted position and the inserted position.

3. The drawer assembly of claim 1, wherein the platform is part of a head assembly, wherein the head assembly is configured and adapted to move vertically with respect to the drawer as the drawer moves from the extracted position to the inserted position.

4. The drawer assembly of claim 3, wherein the drawer includes a ramp element in abutment with a lower surface of the platform of the head assembly, wherein the abutment of ramp element is configured and adapted to vertically raise or lower the head assembly as the drawer moves from the extracted position to the inserted position.

5. The drawer assembly of claim 1, wherein the housing includes at least one guide slot and wherein the platform includes at least one guide pin positioned within the guide slot, wherein the at least one guide pin is configured and adapted to move vertically within the guide slot.

6. The drawer assembly of claim 1, wherein the drawer is configured and adapted to move vertically with respect to the platform as the drawer moves from the extracted position to the inserted position.

7. The drawer assembly of claim 1, wherein the drawer includes at least one guide pin configured and adapted to engage with the at least one track of the housing.

8. The drawer assembly of claim 1, wherein the at least one track of the housing includes a first section defining a first longitudinal axis in a first direction and a second section defining a second longitudinal axis in a second direction, wherein the second direction is at an angle relative to the first direction.

9. The drawer assembly of claim 8, wherein the second section is angled upwards toward a top surface of the housing such that, as the drawer moves from the extracted position and the inserted position, the at least one track guides the at least one guide pin, and thereby the drawer, towards the platform.

10. The drawer assembly of claim 1, wherein the platform is part of a head assembly, the drawer assembly further comprising a gear interface between the head assembly and the drawer.

11. The drawer assembly of claim 10, wherein the gear interface includes a double pinion gear, a first rack gear and a second rack gear, wherein the first rack gear is operatively connected to the drawer for common movement therewith and the second rack gear is operatively connected to the platform for common movement therewith.

12. The drawer assembly of claim 11, wherein a first set of teeth of the double pinion gear are meshed with the first rack gear and wherein a second set of teeth of the double pinion gear are meshed with the second rack gear such that rotation of the pinion gear is configured and adapted to drive at least one of horizontal translation of the first rack gear or vertical translation of the second rack gear.

13. The drawer assembly of claim 10, further comprising an electric motor coupled to the double pinion gear to drive rotation thereof.

14. The drawer assembly of claim 1, wherein the drawer is a single drawer having a plurality of capsule receptacles defined therein.

15. The drawer assembly of claim 1, wherein the drawer is one of a plurality of discretely movable drawers each having at least one respective capsule receptacle defined therein.

16. The drawer assembly of claim 1, wherein the platform is one of a plurality of discretely movable platforms that are part of discretely movable head assemblies, wherein respective capsule puncturing needles are operatively coupled to each platform.

17. The drawer assembly of claim 14, further comprising a respective gear interface engaged with each discretely movable platform.

18. The drawer assembly of claim 17, wherein each gear interface includes a double pinion gear, a first rack gear and a second rack gear, wherein the first rack gear is operatively connected to the drawer for common movement therewith and the second rack gear is operatively connected to a respective one of the discretely movable platforms for common movement therewith.

19. The drawer assembly of claim 17, wherein each gear interface includes a double pinion gear and a rack gear operatively connected to a respective one of the discretely movable platforms for common movement therewith.

20. The drawer assembly of claim 17, further comprising a plurality of electric motors, each electric motor coupled to a respective gear interface.

21. The drawer assembly of claim 1, further comprising a brew timer operatively connected to the platform for triggering a change in a vertical distance between a top surface of the drawer and a lower surface of the platform at a desired time.

22. A beverage making machine comprising:
a drawer assembly comprising:
a housing having at least a one track on an inner side thereof;
a platform located within the housing for receiving a capsule puncturing needle; and
a drawer, having at least one capsule receptacle therein, slidably engaged with the track of the housing; and
a brew timer operatively connected to the drawer assembly for triggering a change in a vertical distance between a top surface of the drawer and a lower surface of the platform at a desired time.

23. A method of operating drawer assembly for a capsule based brewing machine comprising:
translating a drawer along a track of a housing from an extracted position to an inserted position; and
changing a vertical distance between a top surface of the drawer and a lower surface of a platform.

24. The method of claim 22, further comprising puncturing a capsule with a puncturing needle.

25. The method of claim 22, wherein changing the vertical distance between the top surface of the drawer and the lower surface of the platform includes changing the vertical distance as the drawer moves from the extracted position to the inserted position.

26. The method of claim 22, wherein changing the vertical distance between the top surface of the drawer and the lower surface of the platform includes changing the vertical distance after the drawer moves from the extracted position to the inserted position.

27. The method of claim 22, wherein changing the vertical distance between the top surface of the drawer and the lower surface of the platform includes moving platform vertically with respect to the drawer as the drawer moves from the extracted position to the inserted position.

28. The method of claim 22, wherein changing the vertical distance between the top surface of the drawer and the lower surface of the platform includes moving the drawer vertically with respect to the platform as the drawer moves from the extracted position to the inserted position.
